(19) United States
(12) Patent Application Publication
(10) Pub. No.: US 2001/0039995 A1
(43) Pub. Date: Nov. 15, 2001

(54) Process for joining hollow section strips by welding

(76) Inventor: Peter Lisec, Amstetten-Hausmening (AT)

Correspondence Address: YOUNG & THOMPSON, 745 SOUTH 23RD STREET 2ND FLOOR, ARLINGTON, VA, 22202

(21) Appl. No.: 09/850,064

(22) Filed: May 8, 2001

(30) Foreign Application Priority Data
May 9, 2000 (AT) A 808/2000

(51) Int. Cl. B65H 69/08; B23K 31/02; B21D 39/04; B32B 31/26

(52) U.S. Cl. 156/158; 156/309.9; 156/159; 228/165; 228/169

(57) ABSTRACT

To prevent formation of a welding bead in the area of the weld on at least one wall when hollow section strips (1) are being joined by butt welding, on at least one wall of the ends of the hollow section strips (1) to be joined to one another by welding, edges (7) are produced which are set back relative to the end faces (5) of the hollow section strips (1) and the ends of the hollow section strips (1) are moved so close to one another in the execution of the welding process that the edges (7) touch and the welding process ends as soon as the edges (7) touch one another.

The invention relates to a process for joining hollow section strips by welding them.

For example, in the production of spacer frames for insulating glass, hollow section strips consisting of aluminum or a thermoplastic are joined to one another into longer units by welding.

In the production of spacer frames for insulating glass which consist of metal, especially aluminum, closing the frame instead by a straight connector inserted into the ends of the hollow section strips by butt welding the ends of a hollow section strip bent into a frame is known.

A device with which this can be done is known from EP 0 192 921 B1 (U.S. Pat. No. 4,704,512 A). U.S. Pat. No. 4,704,512 A also discloses a process with the features of the introductory part of claim 1.

In the known process for joining hollow section strips by butt welding of the facing end faces of segments of the hollow section strips it is disadvantageous that at the location of the joint a welding bead which projects over the outside contour of the hollow section strip is formed. This welding bead is disruptive especially on the inside surface of a hollow section strip which has been formed into a spacer frame, since it adversely affects the optical impression of the insulating glass pane which has been equipped with this spacer.

In the joining of rods with end disks or nut heads by welding, U.S. Pat. No. 1,004,795 A discloses providing a groove in the end face of the rod so that after the welding process on the outside a welding bead is not visible since the metal which has been displaced in the welding process can be accommodated in the groove.

For butt welding of steel sheet, U.S. Pat. No. 4,912,295 A discloses avoiding deformations of the steel sheet in the edge area by forming the steel sheets sections tapered in the area of the edges which are located transversely to the weld to be produced [sic].

The object of the invention is to devise a process for joining hollow section strips by welding in which in the area of the joint on at least one side, especially the side which is the inner side in a spacer frame, there is no visible welding bead.

This object is achieved as claimed in the invention with a process which has the features of claim 1.

Preferred and advantageous embodiments of process as claimed in the invention are the subject matter of the dependent claims.

In the process as claimed in the invention, before the welding process, on the ends of the hollow section strips to be joined to one another (or the ends of a hollow section strip formed into a frame-like spacer) on at least one surface of the hollow section strip edges are produced which are set back relative to the end faces. Therefore when the hollow section strips are joined or the ends of a hollow section strip are joined to one another, on the side on which there were back-set edges, a weld which is visible from the outside is no longer formed.

It is also advantageous in the process as claimed in the invention that a coating which is provided anyway on the side of the hollow section strip provided with the set-back edge (varnishing or in aluminum hollow section strips a coating produced by anodizing) remains undamaged also in the area of the weld.

The set-back edge in at least one outside surface of the hollow section strip can be produced in the most varied manner. For example, this edge can be produced by a step or a groove being produced.

There can also be an edge which is set back relative to the end face of the hollow section strip in the end faces of hollow section strips and it can extend for example over the entire height of the side surfaces. In this embodiment of the invention welding beads are avoided not only on the side which lies to the interior in a spacer frame, but also in the area of the side surfaces. This can be advantageous since welding beads which can disrupt the application of adhesive or sealing compounds to the side surfaces of the spacer frame are avoided.

Other details, features and advantages of the invention result from the following description of one embodiment of the process as claimed in the invention using the drawings.

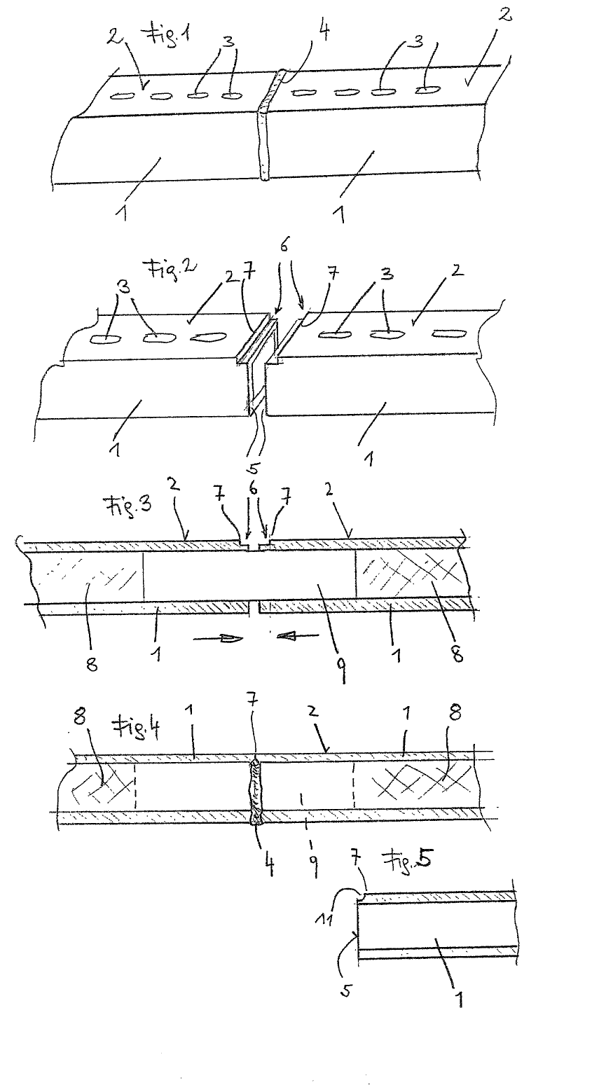

FIG. 1 shows a weld which has been produced using a known process and which joins the ends of the hollow section strips (or the ends of a hollow section strip bent into a frame),

FIG. 2 shows the ends of a hollow section strip prepared for executing the process as claimed in the invention in an oblique view,

FIG. 3 shows in a lengthwise section the ends of hollow section strips prepared for executing the process as claimed in the invention,

FIG. 4 shows in a lengthwise section the hollow section strips after connection by welding and

FIG. 5 shows a modified embodiment for producing a set-back edge.

When the ends of two hollow section strips 1 or the ends of one hollow section strip 1 which has been formed into a frame-like spacer for insulating glass are joined to one another by welding using the known process, in the area of the weld on the hollow section strip 1 a disruptive weld 4 which is visible from the outside is formed. This weld 4 is disruptive especially for frame-like spacers for insulating glass which are made of hollow section strips 1 since it can be seen on the surface 2 of the hollow section strips 1 which form the inside of the space frame (this surface is conventionally provided with openings 3 in order for the hygroscopic material added to the hollow section strip to take effect) since this surface 2 is visible in the finished insulating glass.

In the process as claimed in the invention, the ends of the hollow section strip 1 to be joined to one another, when the ends of the hollow section strip 1 which are bent into a frame-like spacer are to be joined to one another, or the ends of two hollow section strips 1 which are to be joined to one another by welding in order to form a longer hollow section strip, before executing the welding process are each provided with an edge 7 which is set back relative to the end faces 5. These edges 7 are produced at least in the surface 2 which forms the inner surface in the spacer frame. The edges 7 extend over the entire width of the surface 2 of the hollow section strip 1.

In the embodiment shown in FIG. 2, the set-back edges 7 are produced by producing steps 6 in the wall of the hollow section strip 1 which forms the inner surface 2. These steps 6 can be produced by plastic deformation or preferably by removal of material (milling or the like). In any case, it is significant that before the welding process at least in the area of the surfaces 2 which will form or which are already forming the inside of the spacer frame, there are edges 7 which are set back relative to the end faces 5 which are to be joined to one another.

FIG. 3 shows in a lengthwise section the situation from FIG. 2 before executing the welding process for joining the ends of hollow section strips 1 or one hollow section strip 1.

FIG. 3 also shows that a stopper 9, for example made of plastic, is inserted into the ends of the hollow section strip (s) 1 and prevents the hygroscopic material 8 (desiccant) added to the hollow section strip 1 from leaking out. This is important when the ends of a hollow section strip 1 which is already filled with desiccant and formed into a spacer frame are to be joined to one another by welding to close the spacer frame.

In executing the welding process the ends of the hollow section strip 1 are pressed against one another in the direction of the arrows in FIG. 3 and in the welding process are moved so close one another that the edges 7 which are set back originally relative to the end faces 5 adjoin one another at the end of the welding process. Here, in the area of the edges 7, therefore in the area of the surface 2 of the hollow section strips 1, there is no welding bead visible from the outside (compare FIG. 4).

In the invention therefore the motion of the ends of the hollow section strip 1 or the hollow section strip(s) 1 to be welded to one another towards one another and the welding are stopped as soon as the edges 7 touch.

FIG. 4 shows in a lengthwise section the result of a welding process as claimed in the invention for joining the ends of two hollow section strips 1 (or a hollow section strip 1 in a spacer frame). It can be seen that the edges 7 adjoin one another and that a welding bead is not visible there from the outside.

In principle it is irrelevant for the process as claimed in the invention how the edges 7 which are set back over the end faces 5 of the hollow section strips 1 to be joined to one another are made. In addition to the steps 6 shown in FIGS. 2 and 3 the wall of the hollow section strip 1 which forms the surface 2 can also be provided with a groove 11 (FIG. 5).

For reliable joining of hollow section strips 1 or a hollow section strip 1 bent into a spacer frame using the process as claimed in the invention it is advantageous if the end face 5 of the hollow section strip(s) 1 is made narrower in the area of the set-back edges 7, but still remains, so that in the area of the wall which forms the surface 2 reliable joining of the hollow section strip(s) 1 is achieved.

If welding beads are also to be avoided in the area of the side surfaces of the hollow section strip(s) 1 there can be edges 7 which are set back relative to the end faces 5 in the side surfaces of the hollow section strip(s) 1 as well. These edges 7 extend over the entire height of the side surfaces.

In principle, various measures are conceivable for making the edges which are set back relative to the end faces 5 on the ends of the hollow section strip(s) 1 to be joined to one another. Edges which are formed by steps 6 (FIG. 3) or grooves 11 (FIG. 5) have proven especially advantageous for the successful execution of the process as claimed in the invention.

The process as claimed in the invention was described above using the example of joining hollow section strips of metal, especially aluminum. Basically the process as claimed in the invention can also be used for joining hollow section strips of weldable plastic, especially thermoplastic. When hollow section strips of thermoplastic are joined there will be no “welding bead” either due to the edge which is set back on at least one surface after the welding process in the area of this surface, but this surface will be continuous, therefore flat in the area of this weld as well.

In summary, one embodiment of the invention can be described as follows:

To prevent formation of weld beads in the area of the weld on at least one wall in the joining of hollow section strips 1 by butt welding, on at least one wall of the ends of the hollow section strips 1 to be joined to one another by welding, edges 7 are produced which are set back relative to the end faces 5 of the hollow section strips 1 and the ends of the hollow section strips 1 in the execution of the welding process are brought so near one another that the edges 7 touch and the welding process ends as soon as the edges 7 touch one another.

1. Process for joining the ends of hollow section strip(s (1) or the ends of a hollow section strip which has been bent into a frame, by welding, in which the end faces (5) of the ends of the hollow section strip(s) (1) are placed next to one another and during the welding process are moved towards one another, characterized in that before executing the welding process on at least one surface (2) of the ends of the hollow section strip(s) (1) to be joined to one another an edge (7) is produced which extends over the width of the surface (2) and which is set back relative to the end faces (5) of the ends of the hollow section strip(s) (1).

2. Process as claimed in claim 1, wherein the surfaces (2) on the ends of the hollow section strip(s) (1) on which the edges (7) are produced are surfaces (2) of the hollow section strip(s) (1) pointing to the outside.

3. Process as claimed in claim 1 or 2, wherein the ends of the hollow section strip(s) (1) are moved so close to one another during the welding process that the edges (7) touch one another.

4. Process as claimed in one of claims 1 to 3, wherein the edges (7) are produced by machining at least one wall of the hollow section strip(s) (1).

5. Process as claimed in one of claims 1 to 4, wherein in at least one wall of the hollow section strip(s) (1) steps (6) are produced to form the edges (7) which are set back relative to the end faces (5).

6. Process as claimed in one of claims 1 to 4, wherein in at least one wall of the hollow section strip(s) (1) grooves (11) are produced to form the edges (7) which are set back relative to the end faces (5).

7. Process as claimed in one of claims 1 to 6, wherein when hollow section strip(s) (1) which are intended as spacers of insulating glass are joined or when the ends of a hollow section strip (1) which has been formed into a frame-like spacer are joined, the edges (7) which are set back relative to the end faces (5) of the ends of the hollow section strip(s) (1) to be joined to one another are produced on the surface (2) of the hollow section strip (1) which lies to the inside in the insulating glass.
